(19) United States
(12) Patent Application Publication
(10) Pub. No.: US 2026/0291259 A1
(43) Pub. Date: Sep. 24, 2026

(54) SYSTEM FOR MANAGING WORK MACHINE, METHOD FOR MANAGING WORK MACHINE, AND WORK MACHINE

(71) Applicant: KOMATSU LTD., Tokyo (JP)

(72) Inventor: Ryoichi Togashi, Tokyo (JP)

(73) Assignee: KOMATSU LTD., Tokyo (JP)

(21) Appl. No.: 19/477,530

(22) PCT Filed: Mar. 29, 2024
(86) PCT No.: PCT/JP2024/013318

§ 371 Date: Oct. 22, 2025

(30) Foreign Application Priority Data
May 8, 2023 (JP) 2023-076744

(51) Int. Cl. H02J 7/34; E02F 9/20

(52) U.S. Cl. CPC H02J 7/342; E02F 9/2054; E02F 9/2091

(57) ABSTRACT

A system for managing a work machine includes a processor. The processor acquires an amount of charge remaining of a battery of each of a plurality of work machines at a work site, determines whether a first work machine including a battery that needs to be charged is present, determines whether a second work machine including a battery capable of charging the battery of the first work machine is present, and outputs a charging command to charge the battery of the first work machine to the second work machine when the first work machine and the second work machine are determined to be present.

### TECHNICAL FIELD

The present disclosure relates to a system for managing a work machine, a method for managing a work machine, and a work machine.

### BACKGROUND ART

Patent Document 1 discloses a technique related to wireless energy transmission between vehicles.

### CITATION LIST

### Patent Literature

Patent Document 1: US 2021/0323420 A

### SUMMARY OF INVENTION

### Technical Problem

A work machine operates at a work site. An electrically operated work machine includes a battery. The battery is charged at a charging station. A technique for enabling a battery of a work machine to be charged by using a method other than a method of using a charging station has been awaited.

An object of the present disclosure is to charge a battery of a work machine.

### Solution to Problem

According to the present disclosure, a system for managing a work machine is provided. The system for managing a work machine includes a processor. The processor acquires an amount of charge remaining of a battery of each of a plurality of work machines at a work site, determines whether a first work machine including a battery that needs to be charged is present, determines whether a second work machine including a battery capable of charging the battery of the first work machine is present, and outputs a charging command to charge the battery of the first work machine to the second work machine when the first work machine and the second work machine are determined to be present.

### Advantageous Effects of Invention

According to the present disclosure, a battery of a work machine is charged.

### BRIEF DESCRIPTION OF DRAWINGS

FIG. 1 is a diagram illustrating a management system for a work machine according to an embodiment.

FIG. 2 is a diagram illustrating an excavator according to an embodiment.

FIG. 3 is a diagram illustrating a bulldozer according to an embodiment.

FIG. 4 is a diagram illustrating a dump truck according to an embodiment.

FIG. 5 is a diagram illustrating a control system for the work machine according to an embodiment.

FIG. 6 is a block diagram illustrating a management server and an in-vehicle controller according to an embodiment.

FIG. 7 is a diagram illustrating a first example of vehicle-to-vehicle charging according to an embodiment.

FIG. 8 is a diagram illustrating a second example of the vehicle-to-vehicle charging according to an embodiment.

FIG. 9 is a diagram illustrating a third example of the vehicle-to-vehicle charging according to an embodiment.

FIG. 10 is a diagram illustrating an example of a wired charging method according to an embodiment.

FIG. 11 is a diagram illustrating an example of a wireless charging method according to an embodiment.

FIG. 12 is a flowchart illustrating a method for managing the work machine according to an embodiment.

FIG. 13 is a diagram illustrating the excavator according to an embodiment.

FIG. 14 is a diagram illustrating a method for charging a battery according to an embodiment.

FIG. 15 is a diagram illustrating the excavator according to an embodiment.

FIG. 16 is a diagram illustrating a method for charging the battery according to an embodiment.

FIG. 17 is a diagram illustrating the excavator according to an embodiment.

FIG. 18 is a diagram illustrating a method for charging the battery according to an embodiment.

### DESCRIPTION OF EMBODIMENTS

Hereinafter, embodiments according to the present disclosure will be described with reference to the drawings, but the disclosure is not limited to an embodiment. Components of embodiments described below can be combined as appropriate. Some components are not used in some cases.

### First Embodiment

A first embodiment will be described.

### Overview of Management System

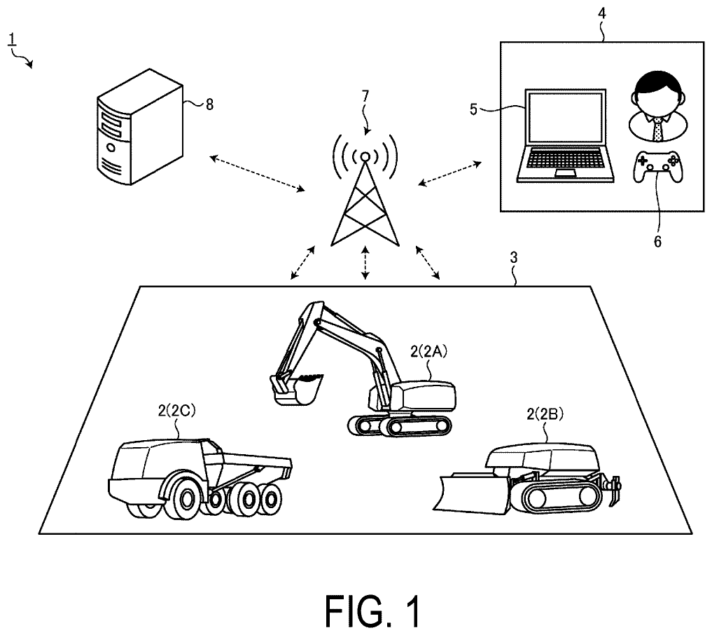

FIG. 1 is a diagram illustrating a management system 1 for a work machine 2 according to an embodiment. The management system 1 manages the work machine 2 operating at a work site 3. In an embodiment, the work machine 2 is an electric work machine that uses a battery as a drive source. A plurality of the work machines 2 are at the work site 3. In the example illustrated in FIG. 1, the work machine 2 at the work site 3 includes an excavator 2A, a bulldozer 2B, and a dump truck 2C.

In an embodiment, operators do not board the work machine 2. The work machine 2 is remotely operated. A remote operation room 4 is installed outside the work machine 2. The remote operation room 4 is installed at a location remote from the work site 3. An information terminal 5 and a remote operation device 6 for remotely operating the work machine 2 are each arranged in the remote operation room 4. Each of the information terminal 5 and the remote operation device 6 is outside the work machine 2. The information terminal 5 includes a computer system disposed in the remote operation room 4.

The remote operation device 6 is operated by an operator in the remote operation room 4. The remote operation device 6 generates, by being operated by the operator, operation signals for remotely operating the work machine 2. The operation signals generated in the remote operation device 6 are input to the information terminal 5. The information terminal 5 generates a remote operation command on the basis of the operation signals from the remote operation device 6. The information terminal 5 transmits the remote operation command to the work machine 2 via a communication system 7.

The work machine 2 operate based on the remote operation command transmitted from the information terminal 5 outside the work machine 2. At least one of the work machine 2 or the work site 3 is provided with a camera that acquires image data of the work site 3. The image data of the work site 3 is transmitted to the information terminal 5 via the communication system 7 and displayed on a display device of the information terminal 5. The operator can operate the remote operation device 6 while checking the image data of the work site 3.

The communication system 7 may include a public communication line or may include a dedicated communication line. The communication system 7 is exemplified by a mobile phone communication network or a satellite communication network. The communication system 7 may include the Internet or may include a local area network.

The management system 1 includes a management server 8. The management server 8 includes a computer system. The management server 8 can communicate with the work machine 2 via the communication system 7. The management server 8 collects operation data of the work machine 2. The management server 8 outputs a control command to the work machine 2.

### Work Machines

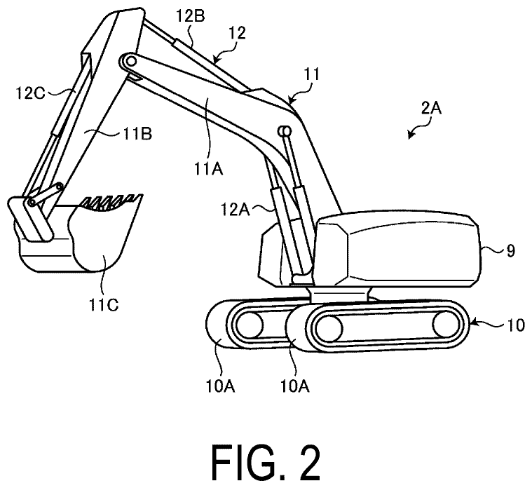

FIG. 2 is a diagram illustrating the excavator 2A according to an embodiment. The excavator 2A includes a revolving body 9, a traveling body 10, a work implement 11, and a work implement cylinder 12.

The revolving body 9 is revolvably supported by the traveling body 10. The traveling body 10 travels supporting the revolving body 9. The traveling body 10 includes a pair of crawler tracks 10A. Rotation of the crawler tracks 10A causes the excavator 2A to travel.

The work implement 11 is coupled to the revolving body 9. The work implement 11 includes a boom 11A coupled to the revolving body 9, an arm 11B coupled to the boom 11A, and a bucket 11C coupled to the arm 11B. The work implement cylinder 12 includes a boom cylinder 12A that operates the boom 11A, an arm cylinder 12B that operates the arm 11B, and a bucket cylinder 12C that operates the bucket 11C.

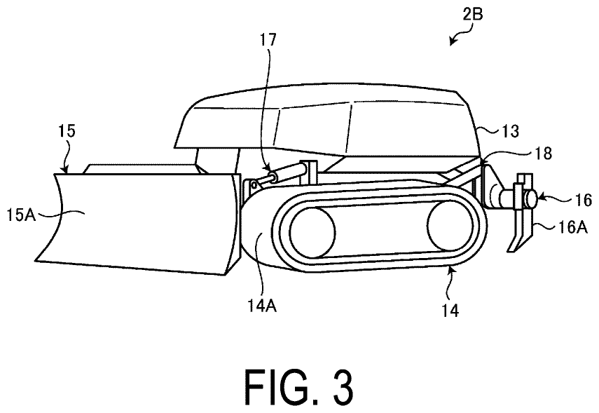

FIG. 3 is a diagram illustrating the bulldozer 2B according to an embodiment. The bulldozer 2B includes a vehicle body 13, a traveling body 14, an excavation work implement 15, a ripper work implement 16, a work implement cylinder 17, and a ripper cylinder 18.

The vehicle body 13 is supported by the traveling body 14. The traveling body 14 travels while supporting the vehicle body 13. The traveling body 14 includes a pair of crawler tracks 14A. Rotation of the crawler tracks 14A causes the bulldozer 2B to travel.

The excavation work implement 15 implements excavation work, bulldozing work, or ground leveling work on a work target. The excavation work implement 15 is attached to the vehicle body 13. At least part of the excavation work implement 15 is disposed at the front of the vehicle body 13. The excavation work implement 15 includes an excavation blade 15A. The work implement cylinder 17 operates the excavation blade 15A.

The ripper work implement 16 implements ripping work on the work target. The work target of the ripper work implement 16 includes the ground of the work site. The ripper work implement 16 is attached to the vehicle body 13. At least part of the ripper work implement 16 is disposed at the rear of the vehicle body 13. The ripper work implement 16 includes a shank 16A. The ripper cylinder 18 operates the shank 16A.

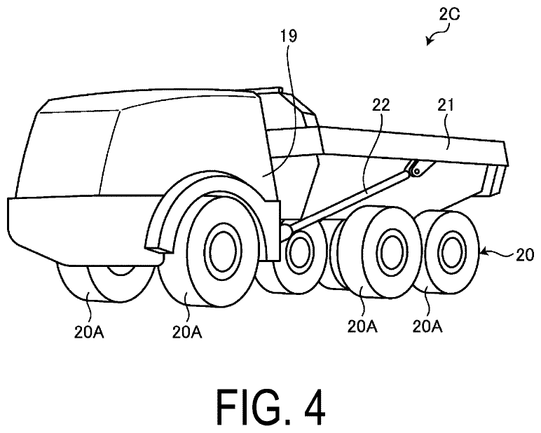

FIG. 4 is a diagram illustrating the dump truck 2C according to an embodiment. As illustrated in FIG. 4, the dump truck 2C includes a vehicle body 19, a traveling device 20, a dump body 21, and a hoist cylinder 22.

The traveling device 20 includes a plurality of wheels 20A and a steering device for steering the wheels 20A. The hoist cylinder 22 raises and lowers the dump body 21. One end portion of the hoist cylinder 22 is rotatably coupled to the vehicle body 19 via a bracket (not illustrated). The other end portion of the hoist cylinder 22 is rotatably coupled to the dump body 21 via a bracket (not illustrated). The dump body 21 is a member on which a shipment is loaded. The dump body 21 is raised and lowered by the operation of the hoist cylinder 22.

### Control System

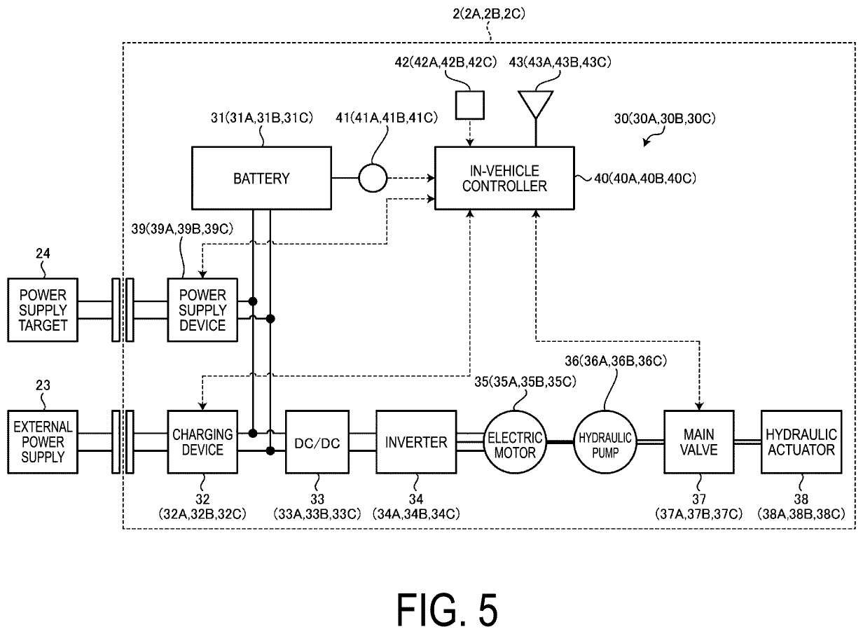

FIG. 5 is a diagram illustrating a control system 30 for the work machine 2 according to an embodiment. The work machine 2 includes the control system 30. The control system 30 includes a battery 31, a charging device 32, a DC/DC converter 33, an inverter 34, an electric motor 35, a hydraulic pump 36, a main valve 37, a hydraulic actuator 38, a power supply device 39, an in-vehicle controller 40, a battery sensor 41, a position sensor 42, and a communication device 43.

The control system 30 includes a control system 30A installed in the excavator 2A, a control system 30B installed in the bulldozer 2B, and a control system 30C installed in the dump truck 2C. The control system 30A, the control system 30B, and the control system 30C have structures and functions that are equivalent to each other.

The control system 30A for the excavator 2A includes a battery 31A, a charging device 32A, a DC/DC converter 33A, an inverter 34A, an electric motor 35A, a hydraulic pump 36A, a main valve 37A, a hydraulic actuator 38A, a power supply device 39A, an in-vehicle controller 40A, a battery sensor 41A, a position sensor 42A, and a communication device 43A.

The control system 30B for the bulldozer 2B includes a battery 31B, a charging device 32B, a DC/DC converter 33B, an inverter 34B, an electric motor 35B, a hydraulic pump 36B, a main valve 37B, a hydraulic actuator 38B, a power supply device 39B, an in-vehicle controller 40B, a battery sensor 41B, a position sensor 42B, and a communication device 43B.

The control system 30C for the dump truck 2C includes a battery 31C, a charging device 32C, a DC/DC converter 33C, an inverter 34C, an electric motor 35C, a hydraulic pump 36C, a main valve 37C, a hydraulic actuator 38C, a power supply device 39C, an in-vehicle controller 40C, a battery sensor 41C, a position sensor 42C, and a communication device 43C.

The battery 31A, the battery 31B, and the battery 31C have equivalent functions. In the following description, the battery 31A, the battery 31B, and the battery 31C are collectively referred to as the battery 31 as appropriate. The same applies to the charging device 32, the DC/DC converter 33, the inverter 34, the electric motor 35, the hydraulic pump 36, the main valve 37, the hydraulic actuator 38, the power supply device 39, the in-vehicle controller 40, the battery sensor 41, the position sensor 42, and the communication device 43.

The battery 31 is a built-in battery installed in the work machine 2. The battery 31 includes a secondary battery. In an embodiment, the battery 31 includes a lithium ion battery (LiB).

The charging device 32 is connected to an external power supply 23 provided outside the work machine 2. The external power supply 23 includes at least one of the battery 31 of another work machine 2, a large battery pack installed at the work site 3, or a charging station. The charging device 32 charges the battery 31 with power supplied from the external power supply 23 The DC/DC converter 33 boosts a voltage from the battery 31. The DC/DC converter 33 supplies direct current from the battery 31 to the inverter 34.

The inverter 34 converts the direct current from the DC/DC converter 33 into three-phase alternating current and supplies this current to the electric motor 35. The electric motor 35 is driven based on the three-phase alternating current supplied from the inverter 34.

The electric motor 35 is a drive source for the work machine 2. The electric motor 35 is driven based on power from the battery 31.

The hydraulic pump 36 is driven by the electric motor 35. The hydraulic pump 36 discharges hydraulic oil. The hydraulic oil discharged from the hydraulic pump 36 is supplied to the hydraulic actuator 38 via the main valve 37. The hydraulic actuator 38A of the excavator 2A includes the work implement cylinder 12. The hydraulic actuator 38B of the bulldozer 2B includes the work implement cylinder 17 and the ripper cylinder 18. The hydraulic actuator 38C of the dump truck 2C includes the hoist cylinder 22.

Instead of the hydraulic actuator 38, an electric actuator may be provided in the work machine 2. The work implement cylinder 12 may be an electric cylinder. Each of the work implement cylinder 17 and the ripper cylinder 18 may be an electric cylinder. The hoist cylinder 22 may be an electric cylinder. When an electric actuator is provided in the work machine 2 instead of the hydraulic actuator 38, the hydraulic pump 36 and the main valve 37 are omitted.

The power supply device 39 is connected to a power supply target 24 provided outside the work machine 2. The power supply device 39 supplies power from the battery 31 to the power supply target 24. The power supply target 24 includes the battery 31 of another work machine 2. The power supply device 39 charges the battery 31 of the other work machine 2 with power supplied from the battery 31.

The in-vehicle controller 40 includes a computer system. The in-vehicle controller 40 controls at least the charging device 32 and the power supply device 39.

The battery sensor 41 includes a voltage sensor to detect the voltage of the battery 31. The position sensor 42 detects the position of the work machine 2. The position of the work machine 2 is detected using the global navigation satellite system (GNSS). The global navigation satellite system includes a global positioning system (GPS). The global navigation satellite system detects the position in the global coordinate system defined by coordinate data of latitude, longitude, and altitude. The global coordinate system refers to a coordinate system fixed to the earth. The position sensor 42 includes a GNSS receiver. The position sensor 42 detects the position of the work machine 2 in the global coordinate system. The communication device 43 wirelessly communicates with the management server 8.

### Management Server and In-Vehicle Controller

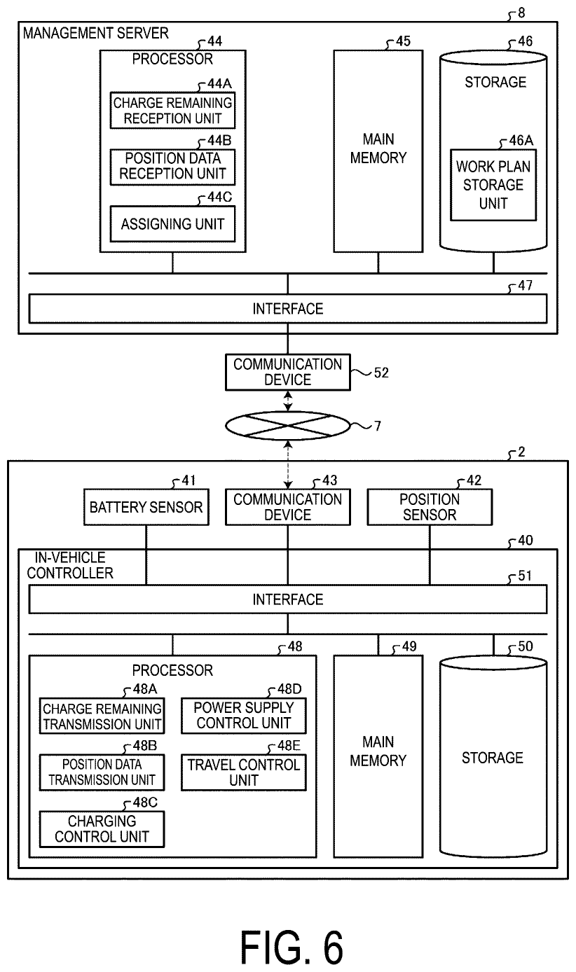

FIG. 6 is a block diagram illustrating the management server 8 and the in-vehicle controller 40 according to an embodiment. The management server 8 and the in-vehicle controller 40 each include a computer system. The management server 8 includes a processor 44 such as a central processing unit (CPU), a main memory 45 including a non-volatile memory such as a read only memory (ROM) and a volatile memory such as a random access memory (RAM), a storage 46, and an interface 47 including an input-output circuit. Functions of the management server 8 are stored in the storage 46 as a computer program. The processor 44 reads out the computer program from the storage 46, loads the computer program into the main memory 45, and executes a process in accordance with the computer program. The computer program may be distributed to the management server 8 via a network.

The in-vehicle controller 40 includes a processor 48, a main memory 49, a storage 50, and an interface 51.

The processor 48 includes a charge remaining calculating unit 48A, a position data transmitting unit 48B, a charging control unit 48C, a power supply control unit 48D, and a travel control unit 48E.

The charge remaining calculating unit 48A calculates the amount of charge remaining of the battery 31 on the basis of detection data from the battery sensor 41. The amount of charge remaining of the battery 31 may be regarded as a state of charge (SOC) of the battery 31. The state of charge of the battery 31 refers to a ratio of the amount of charge remaining to a full charge capacity. The battery sensor 41 detects the voltage of the battery 31. The charge remaining calculating unit 48A can calculate the amount of charge remaining of the battery 31 on the basis of detection data from the battery sensor 41. The charge remaining calculating unit 48A transmits the calculated amount of charge remaining of the battery 31 to the management server 8. The amount of charge remaining of the battery 31 is transmitted to the management server 8 via the communication system 7.

The position data transmitting unit 48B acquires the detection data from the position sensor 42. The detection data from the position sensor 42 indicates the position of the work machine 2. The position data transmitting unit 48B transmits the acquired position of the work machine 2 to the management server 8. The position of the work machine 2 is transmitted to the management server 8 via the communication system 7.

The charging control unit 48C controls the charging device 32. The charging control unit 48C charges the battery 31 based on the power supplied from the external power supply 23.

The power supply control unit 48D controls the power supply device 39. The power supply control unit 48D supplies power to the power supply target 24 based on the power supplied from the battery 31.

The travel control unit 48E controls the travel of the work machine 2. The travel control unit 48E of the in-vehicle controller 40A controls the traveling body 10. The travel control unit 48E of the in-vehicle controller 40B controls the traveling body 14. The travel control unit 48E of the in-vehicle controller 40C controls the traveling device 20.

The processor 44 includes a charge remaining reception unit 44A, a position data reception unit 44B, and an assigning unit 44C. The storage 46 includes a work plan storage unit 46A.

The work plan storage unit 46A stores a work plan for each of the plurality of the work machines 2. The work plan is created by, for example, a manager of the work site 3. Before the work machine 2 operates at the work site 3, the work plan is stored in the work plan storage unit 46A.

The work plan is, for example, a work plan for the work machine 2 in one day. The work plan storage unit 46A stores a work plan for the work machine 2 that operates from, for example, 9 AM to 5 PM.

The charge remaining reception unit 44A acquires an amount of charge remaining of the battery 31 of each of the plurality of the work machines 2 at the work site 3. The charge remaining reception unit 44A receives the amount of charge remaining of the battery 31 transmitted from each of the plurality of the work machines 2 at the work site 3. A communication device 52 is connected to the interface 47. The charge remaining reception unit 44A receives the amount of charge remaining of the battery 31 transmitted from the work machine 2 via the communication system 7 and the communication device 52.

The position data reception unit 44B acquires the position of each of the plurality of the work machines 2 at the work site 3. The position data reception unit 44B receives the position of the work machine 2 transmitted from the work machine 2. The position data reception unit 44B receives the position of the work machine 2 transmitted from the work machine 2 via the communication system 7 and the communication device 52.

The assigning unit 44C outputs a charging command to charge the battery 31 of a first work machine 2 from a second work machine 2 on the basis of the amount of charge remaining of the battery 31 of each of the plurality of the work machines 2. The assigning unit 44C outputs the charging command to charge the battery 31 of the first work machine 2, which needs to be charged, by the second work machine 2 including the battery 31 capable of charging the battery 31 of the first work machine 2. The assigning unit 44C outputs the charging command to charge the battery 31 of the first work machine 2 with a small amount of charge remaining by the second work machine 2 including the battery 31 with a large amount of charge remaining, for example.

The assigning unit 44C may output the charging command to charge the battery 31 of the first work machine 2 by the second work machine 2 on the basis of the amount of charge remaining of the battery 31 of each of the plurality of the work machines 2 and the position of each of the plurality of the work machines 2.

The assigning unit 44C may output the charging command to charge the battery 31 of the first work machine 2 by the second work machine 2 on the basis of the amount of charge remaining of the battery 31 of each of the plurality of the work machines 2 and the work plan for each of the plurality of the work machines 2.

The assigning unit 44C may output the charging command to charge the battery 31 of the first work machine 2 by the second work machine 2 on the basis of the amount of charge remaining of the battery 31 of each of the plurality of the work machines 2 and the work status of each of the plurality of the work machines 2.

### Vehicle-to-Vehicle Charging

In an embodiment, the battery 31 of the first work machine 2 that needs to be charged is charged by the second work machine 2 including the battery 31 capable of charging the battery 31 of the first work machine 2 at the work site 3. The charge remaining reception unit 44A of the management server 8 acquires the amount of charge remaining of the battery 31 of each of the plurality of the work machines 2 at the work site 3. The charge remaining reception unit 44A determines whether the first work machine 2 including the battery 31 that needs to be charged is present on the basis of the amount of charge remaining of the battery 31 of each of the plurality of the work machines 2. The charge remaining reception unit 44A determines whether the second work machine 2 including the battery 31 capable of charging the battery 31 of the first work machine 2 is present on the basis of the amount of charge remaining of the battery 31 of each of the plurality of the work machines 2. When it is determined that the first work machine 2 and the second work machine 2 are present, the assigning unit 44C outputs the charging command to charge the battery 31 of the first work machine 2 to the second work machine 2.

### First Example

For example, at the work site 3, the battery 31 of the first work machine 2 with a small amount of charge remaining is charged by the second work machine 2 including the battery 31 with a large amount of charge remaining.

The battery 31 of the work machine 2 is charged at a charging station before the work machine 2 starts operating. The battery 31 is fully charged at the charging station. The work machine 2 operates at the work site 3 after the battery 31 has been fully charged. Since the power of the battery 31 is consumed when the work machine 2 operates at the work site 3, the amount of charge remaining of the battery 31 gradually decreases.

For example, depending on the work content of the work machine 2, the plurality of the work machines 2 may each have a different amount of charge remaining of the battery 31 even if the operating time is the same. For example, in a case where each of the plurality of the work machines 2 operates at the work site 3 from 9 AM to 5 PM, the work machine 2 with a large amount of charge remaining of the battery 31 of the battery 31 and the work machine 2 with a small amount of charge remaining of the battery 31 may be present at the time point of 1 PM. When no charging station is at the work site 3, the battery 31 is difficult to charge at a charging station after the start of work.

In an embodiment, power is transferred between the plurality of the work machines 2. The work machine 2 including the battery 31 with a large amount of charge remaining charges the battery 31 of the work machine 2 with a small amount of charge remaining.

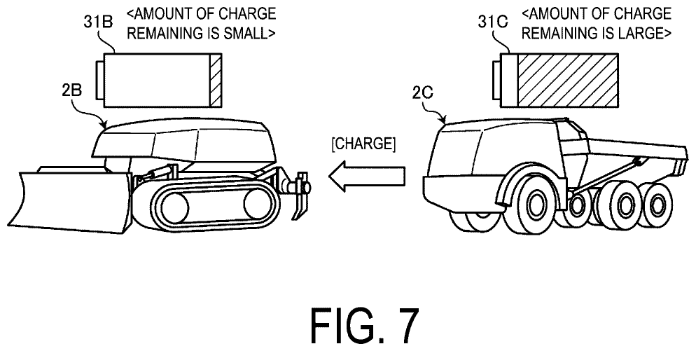

FIG. 7 is a diagram illustrating a first example of the vehicle-to-vehicle charging according to an embodiment. The charge remaining reception unit 44A of the management server 8 acquires the amount of charge remaining of the battery 31 of each of the plurality of the work machines 2 at the work site 3. The charge remaining reception unit 44A determines whether the first work machine 2 with the amount of charge remaining of the battery 31 equal to or less than a predetermined first threshold is present.

Upon determining that the first work machine 2 with a small amount of charge remaining of the battery 31 is present, the charge remaining reception unit 44A determines whether the second work machine 2 including the battery 31 with an amount of charge remaining exceeding the amount of charge remaining of the battery 31 of the first work machine 2 is present.

In the example illustrated in FIG. 7, the bulldozer 2B is the first work machine 2 including the battery 31B with an amount of charge remaining equal to or less than the first threshold. The dump truck 2C is the second work machine 2 including the battery 31C with an amount of charge remaining exceeding the amount of charge remaining of the battery 31B of the bulldozer 2B. The assigning unit 44C determines that the bulldozer 2B including the battery 31B with an amount of charge remaining equal to or less than the first threshold is the first work machine 2 including the battery 31 that needs to be charged. The assigning unit 44C determines that the dump truck 2C including the battery 31C with an amount of charge remaining exceeding the amount of charge remaining of the battery 31B of the bulldozer 2B is the second work machine 2 including the battery 31 capable of charging the battery 31B of the bulldozer 2B. When it is determined that the bulldozer 2B, which is the first work machine 2, and the dump truck 2C, which is the second work machine 2, are present, the assigning unit 44C outputs a charging command to charge the battery 31B of the bulldozer 2B to the dump truck 2C.

The charging command output from the assigning unit 44C is transmitted to the in-vehicle controller 40C of the dump truck 2C. The travel control unit 48E of the dump truck 2C controls the traveling device 20 of the dump truck 2C on the basis of the position of the bulldozer 2B to move the dump truck 2C close to the bulldozer 2B. When the dump truck 2C and the bulldozer 2B become close to each other, the power supply control unit 48D of the dump truck 2C controls the power supply device 39C to charge the battery 31B of the bulldozer 2B.

When a plurality of second work machines 2 including the battery 31 with an amount of charge remaining exceeding the amount of charge remaining of the battery 31B of the bulldozer 2B are present at the work site 3, the assigning unit 44C causes the second work machine 2 including the battery 31 with the largest amount of charge remaining to charge the battery 31B of the bulldozer 2B. When a plurality of dump trucks 2C including the battery 31C with a large amount of charge remaining are present at the work site 3, the assigning unit 44C causes the dump truck 2C including the battery 31C with the largest amount of charge remaining to charge the battery 31B of the bulldozer 2B.

### Second Example

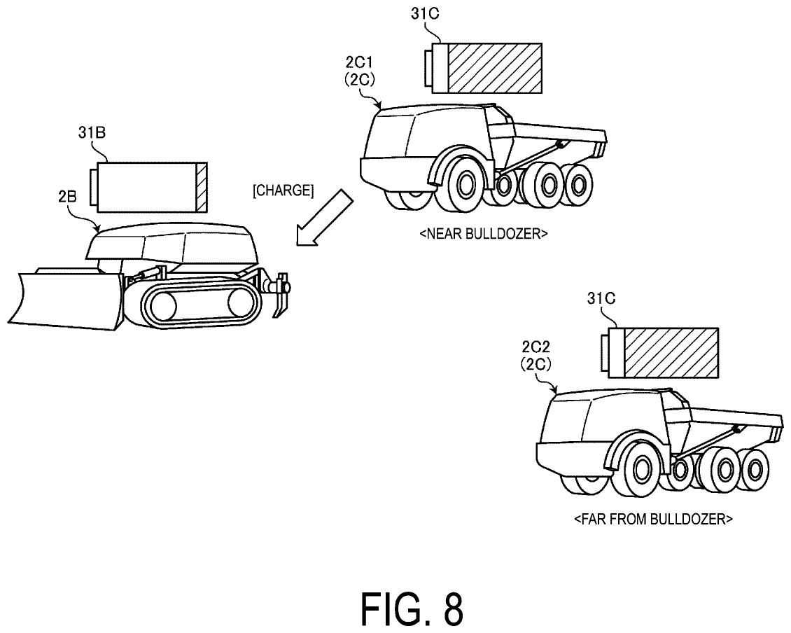

FIG. 8 is a diagram illustrating a second example of the vehicle-to-vehicle charging according to an embodiment. The charge remaining reception unit 44A of the management server 8 acquires the amount of charge remaining of the battery 31 of each of the plurality of the work machines 2 at the work site 3. The charge remaining reception unit 44A determines whether the first work machine 2 with the amount of charge remaining of the battery 31 equal to or less than the predetermined first threshold is present.

Upon determining that the first work machine 2 with a small amount of charge remaining of the battery 31 is present, the charge remaining reception unit 44A determines whether the second work machine 2 including the battery 31 with an amount of charge remaining exceeding the amount of charge remaining of the battery 31 of the first work machine 2 is present.

In the example illustrated in FIG. 8, the bulldozer 2B is the first work machine 2 including the battery 31B with an amount of charge remaining equal to or less than the threshold. A dump truck 2C1 and a dump truck 2C2 are the second work machines 2 including the battery 31C with an amount of charge remaining exceeding the amount of charge remaining of the battery 31B of the bulldozer 2B.

The position data reception unit 44B acquires the position of each of the plurality of the work machines 2 at the work site 3. When a plurality of dump trucks 2C serving as the second work machines 2 are determined to be present, the assigning unit 44C determines the dump truck 2C to charge the battery 31C of the bulldozer 2B on the basis of the position of the bulldozer 2B and the position of each of the plurality of dump trucks 2C (2C1 and 2C2).

The assigning unit 44C calculates the distance between the bulldozer 2B and each of the plurality of dump trucks 2C (2C1, 2C2) on the basis of the position of the bulldozer 2B and the position of each of the plurality of dump trucks (2C2, 2C 2C1). The assigning unit 44C causes the dump truck 2C that is closest to the bulldozer 2B to charge the battery 31B of the bulldozer 2B.

In the example illustrated in FIG. 8, the assigning unit 44C calculates a first distance between the bulldozer 2B and the dump truck 2C1 on the basis of the position of the bulldozer 2B and the position of the dump truck 2C1. The assigning unit 44C calculates a second distance between the bulldozer 2B and the dump truck 2C2 on the basis of the position of the bulldozer 2B and the position of the dump truck 2C2. When the first distance is shorter than the second distance, the assigning unit 44C outputs a charging command to charge the battery 31B of the bulldozer 2B to the dump truck 2C1.

### Third Example

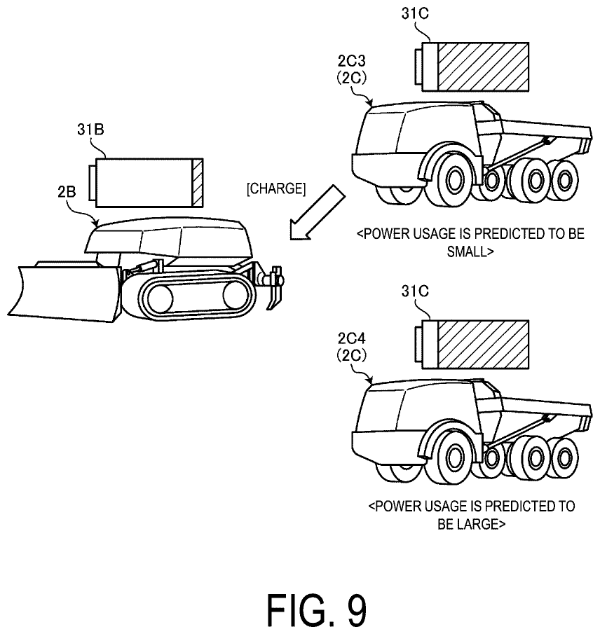

FIG. 9 is a diagram illustrating a third example of the vehicle-to-vehicle charging according to an embodiment. The charge remaining reception unit 44A of the management server 8 acquires the amount of charge remaining of the battery 31 of each of the plurality of the work machines 2 at the work site 3. The assigning unit 44C acquires a work plan for each of the plurality of the work machines 2 at the work site 3. The charge remaining reception unit 44A determines whether the first work machine 2 with the amount of charge remaining of the battery 31 equal to or less than the predetermined first threshold is present.

Upon determining that the first work machine 2 with a small amount of charge remaining of the battery 31 is present, the charge remaining reception unit 44A determines whether the second work machine 2 including the battery 31 with an amount of charge remaining exceeding the amount of charge remaining of the battery 31 of the first work machine 2 is present.

In the example illustrated in FIG. 9, the bulldozer 2B is the first work machine 2 including the battery 31B with an amount of charge remaining equal to or less than the first threshold. A dump truck 2C3 and a dump truck 2C4 are the second work machines 2 including the battery 31C with an amount of charge remaining exceeding the amount of charge remaining of the battery 31B of the bulldozer 2B.

When a plurality of dump trucks 2C serving as the second work machines 2 are determined to be present, the assigning unit 44C calculates a predicted value of power usage of each of the plurality of dump trucks 2C on the basis of the work plan for each of the plurality of dump trucks 2C. The assigning unit 44C determines the dump truck 2C to charge the battery 31B of the bulldozer 2B on the basis of the predicted values of the power usage of the plurality of dump trucks 2C (2C3, 2C4).

For example, when the battery 31B of the bulldozer 2B is charged at 1 PM, the assigning unit 44C predicts the power usage of the dump truck 2C3 from 1 PM to 5 PM on the basis of the work plan for the dump truck 2C3 from 1 PM to 5 PM. The assigning unit 44C predicts the power usage of the dump truck 2C4 from 1 PM to 5 PM on the basis of the work plan for the dump truck 2C4 from 1 PM to 5 PM.

The power usage of the battery 31 varies depending on the work content of the work machine 2. For example, when the transportation work scheduled to be performed by the dump truck 2C3 is small in a period from 1 PM to 5 PM, the predicted value of the power usage of the dump truck 2C3 is small. For example, when the transportation work scheduled to be performed by the dump truck 2C4 is large in a period from 1 PM to 5 PM, the predicted value of the power usage of the dump truck 2C4 is large.

The assigning unit 44C causes the dump truck 2C having the smallest predicted value of the power usage to charge the battery 31B of the bulldozer 2B.

In the example illustrated in FIG. 9, the assigning unit 44C calculates a first predicted value of the power usage of the dump truck 2C3 on the basis of the work plan for the dump truck 2C3. The assigning unit 44C calculates a second predicted value of the power usage of the dump truck 2C4 on the basis of the work plan for the dump truck 2C4. When the first predicted value is smaller than the second predicted value, the assigning unit 44C outputs a charging command to charge the battery 31B of the bulldozer 2B to the dump truck 2C3. Since the predicted value of the power usage of the dump truck 2C3 is small, the dump truck 2C3 can operate until 5 PM even if the power is supplied from the battery 31C of the dump truck 2C3 to the battery 31B of the bulldozer 2B.

When a plurality of dump trucks 2C serving as the second work machines 2 are determined to be present, the assigning unit 44C may calculate the predicted value of the amount of charge remaining of the battery 31C of the dump truck 2C when the work of each of the plurality of dump trucks 2C ends on the basis of the work plan for each of the plurality of dump trucks 2C. The assigning unit 44C may determine the dump truck 2C to charge the battery 31B of the bulldozer 2B on the basis of the predicted value of the amount of charge remaining of the battery 31C when the work of the plurality of dump trucks 2C (2C3, 2C4) ends. The assigning unit 44C causes the dump truck 2C including the battery 31C with the largest predicted value of the amount of charge remaining to charge the battery 31B of the bulldozer 2B.

The assigning unit 44C calculates the predicted values of the amounts of charge remaining of the batteries 31C of the plurality of dump trucks 2C (2C3, 2C4), for example, at 5 PM on the basis of the work plan for each of the plurality of dump trucks 2C (2C3, 2C4). The assigning unit 44C calculates a third predicted value of the amount of charge remaining of the battery 31C of the dump truck 2C3 at 5 PM when the work of the dump truck 2C3 ends on the basis of the work plan for the dump truck 2C3. The assigning unit 44C calculates a fourth predicted value of the amount of charge remaining of the battery 31C of the dump truck 2C4 at 5 PM when the work of the dump truck 2C4 ends on the basis of the work plan for the dump truck 2C4. When the third predicted value is larger than the fourth predicted value, the assigning unit 44C outputs a charging command to charge the battery 31B of the bulldozer 2B to the dump truck 2C3. Since the predicted value of the amount of charge remaining of the battery 31C of the dump truck 2C3 is large, the dump truck 2C3 can operate until 5 PM even if the power is supplied from the battery 31C of the dump truck 2C3 to the battery 31B of the bulldozer 2B.

Fourth Example When a plurality of second work machines 2 are present, the assigning unit 44C may determine the second work machine 2 to charge the battery 31 of the first work machine 2 on the basis of operation data of each of the plurality of second work machines 2.

As described above, the management server 8 collects operation data of the work machine 2. The operation data includes an operation status of the work machine 2. The operation status includes in-operation and not in operation of the work machine 2. The work machine 2 is provided with a state sensor to detect the operation data. The assigning unit 44C can determine whether the work machine 2 is in operation or not in operation on the basis of the detection data from the state sensor.

The assigning unit 44C may determine the second work machine 2 to charge the battery 31 of the first work machine 2 on the basis of operation data of each of the plurality of second work machines 2. As described above, the management server 8 collects operation data of the work machine 2. The operation data includes an operation status of the work machine 2. The operation status includes in-operation and not in operation of the work machine 2. The work machine 2 is provided with a state sensor to detect the operation data. The assigning unit 44C can determine whether the work machine 2 is in operation or not in operation on the basis of the detection data from the state sensor. The assigning unit 44C may output a charging command to charge the battery 31 of the first work machine 2 to the second work machine 2 that is not in operation, for example.

### Fifth Example

The assigning unit 44C may determine whether the first work machine 2 including the battery 31 that needs to be charged is present on the basis of the scheduled work and the amount of charge remaining of the battery 31 of each of the plurality of the work machines 2. The scheduled work of each of the plurality of the work machines 2 is determined based on the work plan described above. The assigning unit 44C may determine the work machine 2 determined to use up the amount of charge remaining of the battery 31 by the end of the scheduled work to be the first work machine 2 that needs to be charged. The assigning unit 44C determines whether the amount of charge remaining of the battery 31 is used up by the end of the scheduled work on the basis of the time or load required for the scheduled work. The longer the time required for the scheduled work, the higher the possibility that the amount of charge remaining of the battery 31 will be used up at the end of the scheduled work. The larger the load required for the scheduled work, the higher the possibility that the amount of charge remaining of the battery 31 will be used up at the end of the scheduled work. The assigning unit 44C determines that the work machine 2 determined to use up the amount of charge remaining of the battery 31 by the end of the scheduled work is the first work machine 2 including the battery 31 that needs to be charged on the basis of the time or load required for the scheduled work.

### Sixth Example

The assigning unit 44C may determine a work machine with an amount of charge remaining of the battery 31 equal to or more than a predetermined second threshold to be the second work machine including the battery 31 capable of charging the battery 31 of the first work machine 2. The second threshold is greater than the first threshold described above.

### Seventh Example

The assigning unit 44C may determine whether the second work machine 2 including the battery 31 capable of charging the battery 31 of the first work machine 2 is present on the basis of the scheduled work and the amount of charge remaining of the battery 31 of each of the plurality of the work machines 2. The scheduled work of each of the plurality of the work machines 2 is determined based on the work plan described above. The assigning unit 44C may determine the work machine 2 determined to still have an amount of charge remaining of the battery 31 at the end of the scheduled work to be the second work machine 2 including the battery 31 capable of charging the battery 31 of the first work machine 2. The assigning unit 44C determines whether the battery 31 still has the amount of charge remaining at the end of the scheduled work on the basis of the time or load required for the scheduled work. The shorter the time required for the scheduled work, the higher the possibility that the battery 31 still has the amount of charge remaining at the end of the scheduled work. The smaller the time required for the scheduled work, the higher the possibility that the battery 31 still has the amount of charge remaining at the end of the scheduled work. The assigning unit 44C determines the work machine 2 determined to still have an amount of charge remaining of the battery 31 at the end of the scheduled work to be the second work machine 2 including the battery 31 capable of charging the battery 31 of the first work machine 2 on the basis of the time or load required for the scheduled work.

### Eighth Example

Regardless of the charging command from the assigning unit 44C, the in-vehicle controller 40 of the second work machine 2 may acquire the an amount of charge remaining of the battery 31 of another work machine 2 at the work site 3, determine whether another work machine 2 including the battery 31 that needs to be charged is present, and output the charging command to charge the battery 31 of the other work machine 2 upon determining that the other work machine 2 including the battery 31 that needs to be charged is present. For example, the work machine 2 for charging (second work machine 2) including the battery 31 with a large capacity may be deployed at the work site 3, and this work machine 2 for charging may collect the amount of charge remaining of the battery 31 of the other work machine 2 at the work site 3 and charge the battery 31 of another work machine 2 with a small amount of charge remaining.

### Charging Method

When the dump truck 2C charges the battery 31B of the bulldozer 2B, the dump truck 2C may charge the battery 31B of the bulldozer 2B by wire or wirelessly.

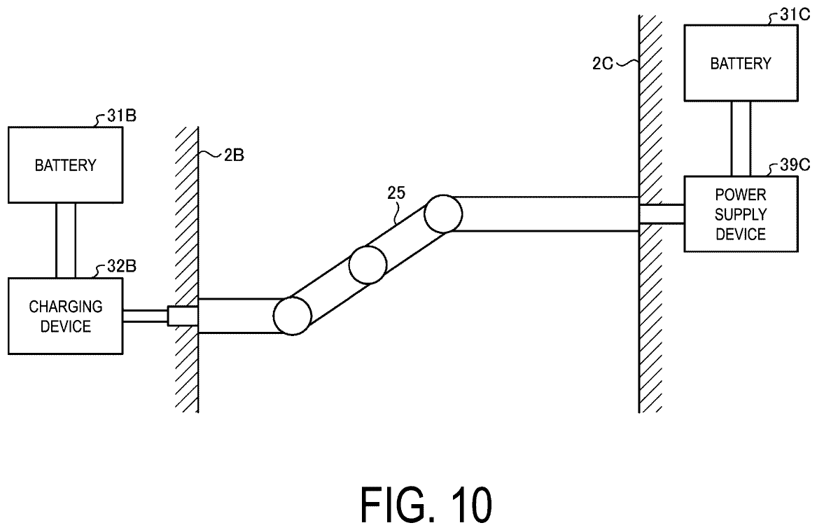

FIG. 10 is a diagram illustrating a method for charging the battery 31B with a wired charging method according to an embodiment. The power supply control unit 48D of the dump truck 2C charges the battery 31B of the bulldozer 2B by wire on the basis of the charging command received from the assigning unit 44C. A base end portion of a power supply arm 25 is connected to the power supply device 39C of the dump truck 2C. A distal end portion of the power supply arm 25 is connected to a power supply port of the bulldozer 2B. The power supply port of the bulldozer 2B is connected to the charging device 32B of the bulldozer 2B. The power supply device 39C of the dump truck 2C supplies power to the charging device 32B of the bulldozer 2B with the power supply arm 25 connected to the power supply port of the bulldozer 2B. The power supply device 39C supplies the power from the battery 31C to the charging device 32B via the power supply arm 25. The battery 31B of the bulldozer 2B is charged by supplying the power from the battery 31C of the dump truck 2C to the charging device 32B.

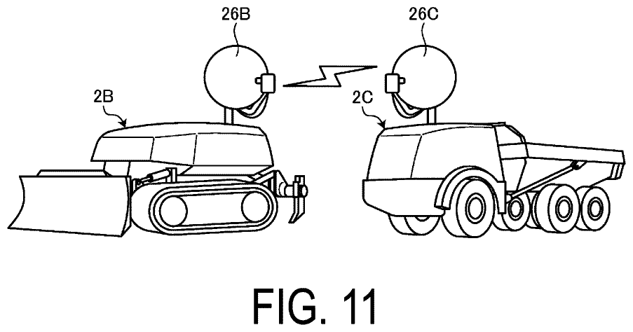

FIG. 11 is a diagram illustrating an example of a wireless charging method according to an embodiment. The power supply control unit 48D of the dump truck 2C wirelessly charges the battery 31B of the bulldozer 2B on the basis of the charging command received from the assigning unit 44C. The dump truck 2C is provided with a wireless power feeder 26C, and the bulldozer 2B is provided with a wireless power receiver 26B. In the dump truck 2C, the wireless power feeder 26C is connected to the power supply device 39C. In the bulldozer 2B, the wireless power receiver 26B is connected to the charging device 32B. The power supply device 39C supplies the power from the battery 31C to the wireless power feeder 26C. The wireless power feeder 26C wirelessly supplies the power from the battery 31C to the wireless power receiver 26B. The power supplied to the wireless power receiver 26B is supplied to the charging device 32B. The battery 31B of the bulldozer 2B is charged by supplying the power from the battery 31C of the dump truck 2C to the charging device 32B.

### Management Method

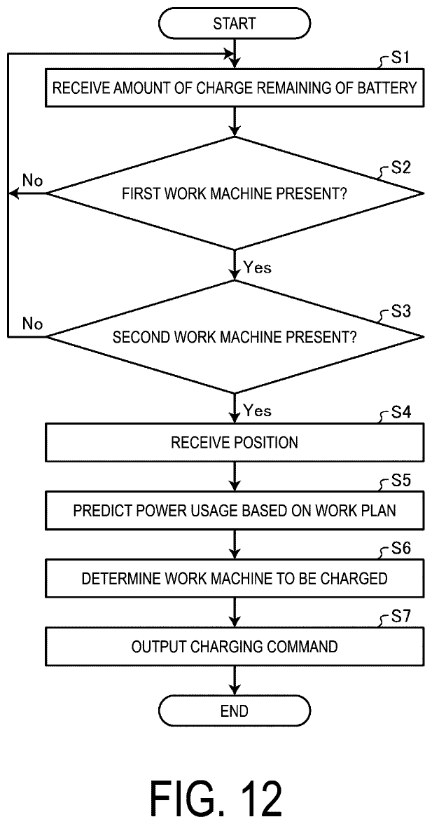

FIG. 12 is a flowchart illustrating a method for managing the work machine 2 according to an embodiment. The charge remaining reception unit 44A of the management server 8 receives the amount of charge remaining of the battery 31 of each of the plurality of the work machines 2 at the work site 3 (step S1).

The charge remaining reception unit 44A determines whether the first work machine 2 with an amount of charge remaining of the battery 31 equal to or less than a predetermined threshold is present (step S2).

When the first work machine 2 is determined not to be present in step S2 (step S2: No), the processing returns to step S1. When it is determined that the first work machine 2 is present in step S2 (step S2: Yes), the charge remaining reception unit 44A determines whether the second work machine 2 including the battery 31 with an amount of charge remaining exceeding the amount of charge remaining of the battery 31 of the first work machine 2 is present (step S3).

When the second work machine 2 is determined not to be present in step S3 (step S3: No), the processing returns to step S1. When the second work machine 2 is determined to be present at step S3 (step S3: Yes), the position data reception unit 44B receives the position of the first work machine 2 and the position of the second work machine 2 at the work site 3 (step S4).

The assigning unit 44C acquires the work plan for the second work machine 2 from the work plan storage unit 46A. The assigning unit 44C predicts the power usage of the second work machine 2 on the basis of the work plan (step S5).

When a plurality of second work machines 2 are present, the assigning unit 44C determines the second work machine 2 to charge the battery 31 of the first work machine 2 on the basis of the position of the first work machine 2 and the positions of the second work machines 2. The assigning unit 44C determines the second work machine 2 to charge the battery 31 of the first work machine 2 on the basis of the predicted value of the power usage of the second work machine 2 (step S6).

The assigning unit 44C outputs the charging command to cause the second work machine 2 determined in step S6 to charge the battery 31 of the first work machine 2 (step S7).

The assigning unit 44C transmits the charging command to the in-vehicle controller 40 of the second work machine 2 determined in step S6. The in-vehicle controller 40 that has received the charging command causes the second work machine 2 to approach the first work machine 2 and then causes the power supply device 39 of the second work machine 2 to supply power to the charging device 32 of the first work machine 2.

The assigning unit 44C may transmit the charging command to the information terminal 5 for remotely operating the work machine 2. When the information terminal 5 receives the charging command, a message indicating that the charging command has been received is displayed on a display of the information terminal 5. After checking the message on the display, the operator may remotely operate the work machine 2 to cause the second work machine 2 to charge the battery 31 of the first work machine 2.

### Effects

As described above, according to an embodiment, the vehicle-to-vehicle charging is performed among the plurality of the work machines 2 at the work site 3. The battery 31 of the first work machine 2, which needs to be charged, is charged by the second work machine 2 including the battery 31 capable of charging the battery 31 of the first work machine 2. This causes the battery 31 of the first work machine 2 to be charged, for example, even if a charging station is not at the work site 3 or is in the vicinity of the work site 3. As a result, the first work machine 2 can continually operate.

### Second Embodiment

A second embodiment will be described. In the following description, components that are the same as or equivalent to those of the first embodiment described above are denoted by the same reference signs, and description of the components is simplified or omitted.

### Management Method

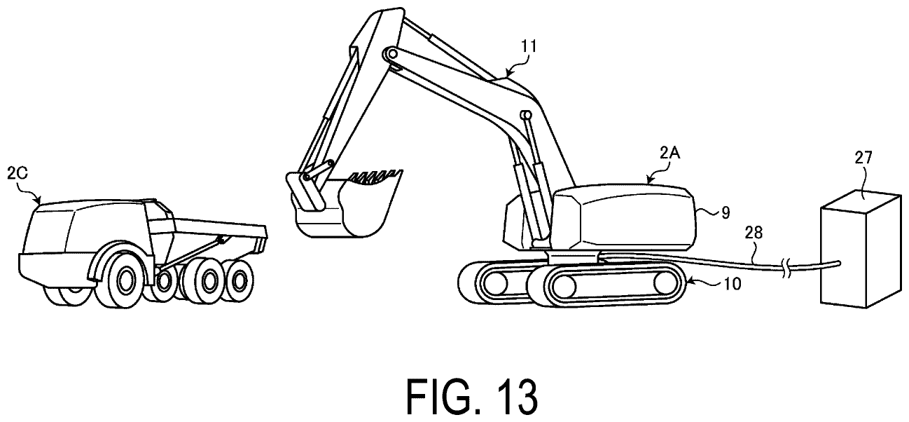

FIG. 13 is a diagram illustrating the excavator 2A according to an embodiment. In the example illustrated in FIG. 13, an external power supply 27 is connected to the excavator 2A. The external power supply 27 is a commercial power supply or a large battery pack. The charging device 32A of the excavator 2A is connected to the external power supply 27 through a cable 28. The power supply device 39A of the excavator 2A can be connected to the external power supply 27. In an embodiment, the power supply device 39A of the excavator 2A is connected to the external power supply 27 via the battery 31A, the charging device 32A, and the cable 28.

The power supply device 39A of the excavator 2A supplies power to the dump truck 2C, which is the power supply target, with the charging device 32A connected to the external power supply 27 through the cable 28. In an embodiment, the power supply device 39A of the excavator 2A supplies power to the dump truck 2C, which is the power supply target, with the power supplied from the external power supply 27 to the charging device 32A through the cable 28. The battery 31C of the dump truck 2C is charged with the power supplied from the excavator 2A.

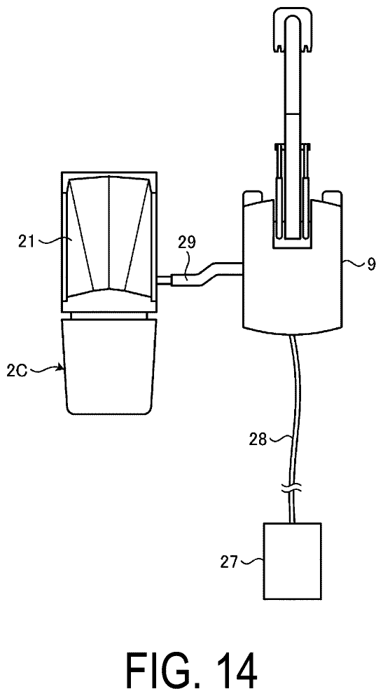

FIG. 14 is a diagram illustrating a method for charging the battery 31C according to an embodiment. The excavator 2A performs loading work of loading a shipment on the dump truck 2C including the battery 31C by using the work implement 11. As illustrated in FIG. 14, when the loading work is performed, the dump truck 2C moves to a loading position adjacent to the excavator 2A. In the loading work, the dump truck 2C stops at the loading position.

The power supply device 39A of the excavator 2A supplies power to the dump truck 2C during the loading work. In the example illustrated in FIG. 14, the power supply device 39A supplies power to the dump truck 2C by wire. A base end portion of a power supply arm 29 is connected to the power supply device 39A of the excavator 2A. The base end portion of the power supply arm 29 is connected to the traveling body 10. The power supply arm 29 extends from the traveling body 10. A distal end portion of the power supply arm 29 is connected to a power supply port of the dump truck 2C. The power supply port of the dump truck 2C is connected to the charging device 32C of the dump truck 2C. The power supply device 39A of the excavator 2A supplies power to the charging device 32C of the dump truck 2C with the power supply arm 29 connected to the power supply port of the dump truck 2C. The power supply device 39A of the excavator 2A supplies the power from the battery 31A to the charging device 32C via the power supply arm 29. The battery 31C of the dump truck 2C is charged by supplying the power from the battery 31A of the excavator 2A to the charging device 32C of the dump truck 2C.

In the loading work, the dump truck 2C stops at the loading position. In the loading work, the revolving body 9 and the work implement 11 of the excavator 2A operate, whereas the traveling body 10 substantially stops. The power supply arm 29 extends from the traveling body 10. Therefore, the excavator 2A can charge the battery 31C of the dump truck 2C during the loading work.

When the loading work ends, the power supply arm 29 is removed from the power supply port of the dump truck 2C. After the power supply arm 29 is removed from the power supply port, the dump truck 2C starts traveling and leaves the loading position. After the dump truck 2C has left the loading position, the next dump truck 2C moves to the loading position. The excavator 2A starts the loading work of loading a shipment onto the next dump truck 2C. In the loading work, the battery 31C of the dump truck 2C is charged with the power supply arm 29 connected to the power supply port of the dump truck 2C.

The charging device 32A of the excavator 2A is connected to the external power supply 27 through the cable 28. The charging device 32A charges the battery 31A of the excavator 2A constantly or periodically with the power from the external power supply 27. This enables the excavator 2A to charge the battery 31A of each of the plurality of dump trucks 2C with the power of the battery 31C.

### Effects

As described above, the power supply device 39A of the excavator 2A supplies power to the dump truck 2C, which is the power supply target, with the charging device 32A connected to the external power supply 27. The battery 31A of the excavator 2A is charged with the power supplied from the external power supply 27. The battery 31C of the dump truck 2C is charged with the power supplied from the battery 31A of the excavator 2A to the dump truck 2C. The charging device 32A of the excavator 2A charges the battery 31A of the excavator 2A constantly or periodically with the power from the external power supply 27. This enables the excavator 2A to sequentially charge the battery 31C of each of the plurality of dump trucks 2C with the power of the battery 31A.

In the loading work, the dump truck 2C stops, allowing the excavator 2A to smoothly charge the battery 31C of the dump truck 2C. In the loading work, the dump truck 2C may stop for several minutes. The dump truck 2C can use stoppage time for charging the battery 31C.

### Third Embodiment

A third embodiment will be described. In the following description, components that are the same as or equivalent to those of the first embodiment described above are denoted by the same reference signs, and description of the components is simplified or omitted.

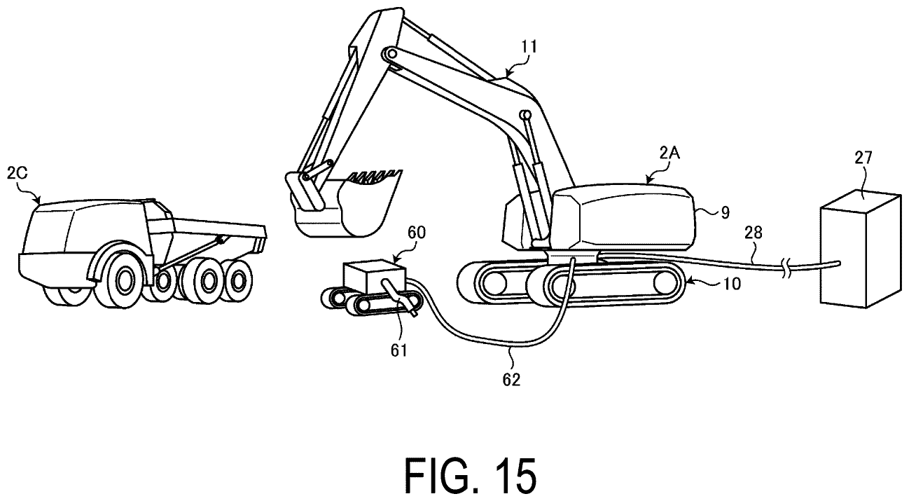

FIG. 15 is a diagram illustrating the excavator 2A according to an embodiment. As illustrated in FIG. 15, the charging device 32A of the excavator 2A is connected to the external power supply 27 through the cable 28.

The power supply device 39A of the excavator 2A is connected to a traveling robot 60 through a cable 62. The traveling robot 60 includes a power supply arm 61. The power from the battery 31A is supplied to the power supply arm 61 via the power supply device 39A, the cable 62, and the traveling robot 60. The power supply device 39A supplies power with the power supply arm 61 of the traveling robot 60 connected to the power supply port of the dump truck 2C.

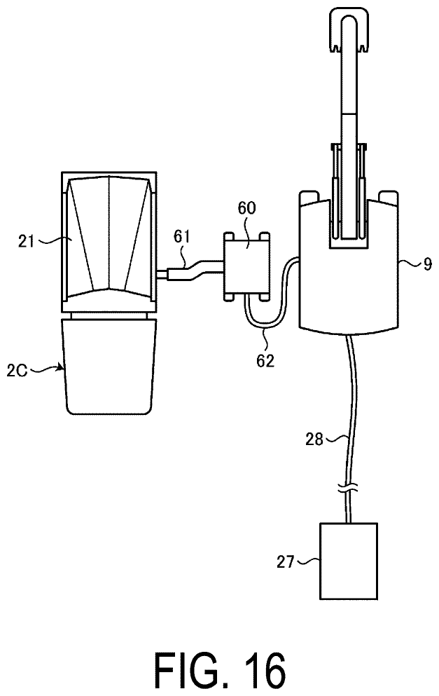

FIG. 16 is a diagram illustrating a method for charging the battery 31C according to an embodiment. For the loading work, the dump truck 2C stops at the loading position.

The power supply device 39A of the excavator 2A supplies power to the dump truck 2C during the loading work. In the loading work, the traveling robot 60 travels to the vicinity of the dump truck 2C. After approaching the power supply port of the dump truck 2C, the traveling robot 60 connects a distal end portion of the power supply arm 61 to the power supply port of the dump truck 2C. The power supply device 39A of the excavator 2A supplies power to the charging device 32C of the dump truck 2C with the power supply arm 61 connected to the power supply port of the dump truck 2C. The power supply device 39A of the excavator 2A supplies the power from the battery 31A to the charging device 32C through the cable 62, the traveling robot 60, and the power supply arm 61. The battery 31C of the dump truck 2C is charged by supplying the power from the battery 31A of the excavator 2A to the charging device 32C of the dump truck 2C.

When the loading work ends, the power supply arm 61 is removed from the power supply port of the dump truck 2C. After the power supply arm 61 is removed from the power supply port, the dump truck 2C starts traveling and leaves the loading position.

### Fourth Embodiment

A fourth embodiment will be described. In the following description, components that are the same as or equivalent to those of the first embodiment described above are denoted by the same reference signs, and description of the components is simplified or omitted.

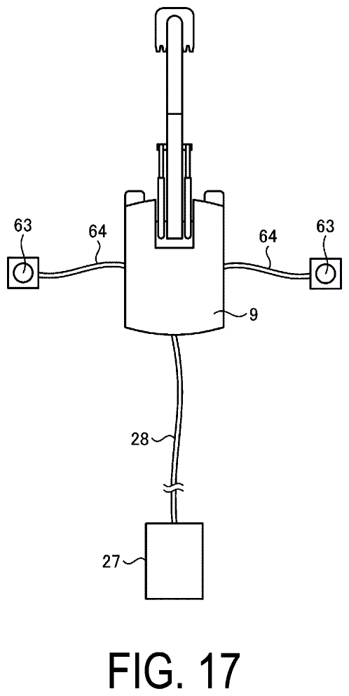

FIG. 17 is a diagram illustrating the excavator 2A according to an embodiment. As illustrated in FIG. 17, the charging device 32A of the excavator 2A is connected to the external power supply 27 through the cable 28.

In an embodiment, the power supply device 39A of the excavator 2A wirelessly supplies power to the dump truck 2C. A charging pad 63 is connected to the power supply device 39A of the excavator 2A through a cable 64. The power from the battery 31A is supplied to the charging pad 63 via the power supply device 39A and the cable 62.

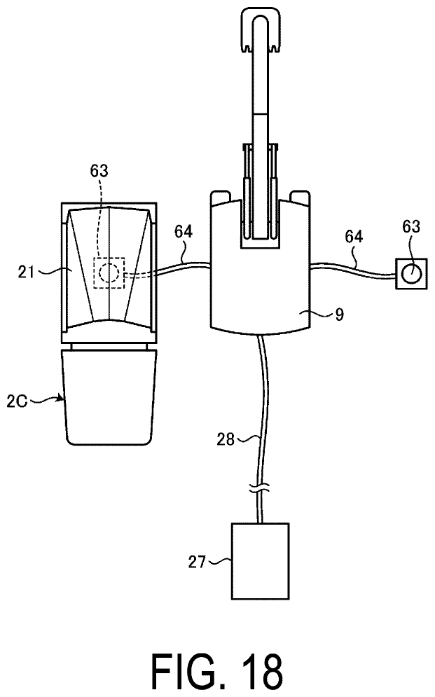

FIG. 18 is a diagram illustrating a method for charging the battery 31C according to an embodiment. The charging pad 63 is installed at the loading position. The charging pad 63 is installed on the ground. The dump truck 2C moves to the loading position to be parked over the charging pad 63. In the loading work, the dump truck 2C stops at the loading position. The dump truck 2C is positioned above the charging pad 63.

The power supply device 39A of the excavator 2A supplies power to the dump truck 2C during the loading work. The power supply device 39A of the excavator 2A supplies power to the charging pad 63 with the dump truck 2C positioned above the charging pad 63. The power supply device 39A of the excavator 2A supplies the power from the battery 31A to the charging pad 63 through the cable 64.

The charging pad 63 charges the battery 31C of the dump truck 2C. The charging pad 63 may be a contact charging pad that charges the battery 31C upon coming into contact with at least part of the dump truck 2C or may be a non-contact charging pad (wireless charging pad) that charges the battery 31C without coming into contact with the dump truck 2C. The contact charging pad has a power supply terminal to be connected to a power receiving terminal provided in the dump truck 2C. The contact charging pad allows for fast charging of the battery 31C. The wireless charging pad wirelessly charges the battery 31C of the dump truck 2C. With the dump truck 2C positioned above the wireless charging pad, a short distance is achieved between the wireless charging pad and the battery 31C of the dump truck 2C. This enables the wireless charging pad to wirelessly charge the battery 31C of the dump truck 2C.

When the loading work ends, the dump truck 2C starts traveling to leave the loading position. When the dump truck 2C leaves the loading position and the charging pad 63 and the dump truck 2C are separated from each other, the charging of the battery 31C ends.

### REFERENCE SIGNS LIST

1 Management system, 2 Work machine, 2A Excavator, 2B Bulldozer, 2C Dump truck, 2C1 Dump truck, 2C2 Dump truck, 2C3 Dump truck, 2C4 Dump truck, 3 Work site, 4 Remote operation room, 5 Information terminal, 6 Remote operation device, 7 Communication system, 8 Management server, 9 Revolving body, 10 Traveling body, 10A crawler track, 11 Work implement, 11A Boom, 11B Arm, 11C Bucket, 12 Work implement cylinder, 12A Boom cylinder, 12B Arm cylinder, 12C Bucket cylinder, 13 Vehicle body, 14 Traveling body, 14A Crawler track, 15 Excavation work implement, 15A Excavation blade, 16 Ripper work implement, 16A Shank, 17 Work implement cylinder, 18 Ripper cylinder, 19 Vehicle body, 20 Traveling device, 20A Wheel, 21 Dump body, 22 Hoist cylinder, 23 External power supply, 24 Power supply target, 25 Power supply arm, 26B Wireless power receiver, 26C Wireless power feeder, 27 External power supply, 28 Cable, 29 Power supply arm, 30 Control system, 30A Control system, 30B Control system, 30C Control system, 31 Battery, 31A Battery, 31B Battery, 31C Battery, 32 Charging device, 32A Charging device, 32B Charging device, 32C Charging device, 33 DC/DC converter, 33A DC/DC converter, 33B DC/DC converter, 33C DC/DC converter, 34 Inverter, 34A Inverter, 34B Inverter, 34C Inverter, 35 Electric motor, 35A Electric motor, 35B Electric motor, 35C Electric motor, 36 Hydraulic pump, 36A Hydraulic pump, 36B Hydraulic pump, 36C Hydraulic pump, 37 Main valve, 37A Main valve, 37B Main valve, 37C Main valve, 38 Hydraulic actuator, 38A Hydraulic actuator, 38B Hydraulic actuator, 38C Hydraulic actuator, 39 Power supply device, 39A Power supply device, 39B Power supply device, 39C Power supply device, 40 In-vehicle controller, 40A In-vehicle controller, 40B In-vehicle controller, 40C In-vehicle controller, 41 Battery sensor, 41A Battery sensor, 41B Battery sensor, 41C Battery sensor, 42 Position sensor, 42A Position sensor, 42B Position sensor, 42C Position sensor, 43 Communication device, 43A Communication device, 43B Communication device, 43C Communication device, 44 Processor, 44A Charge remaining reception unit, 44B Position data reception unit, 44C Assigning unit, 45 Main memory, 46 Storage, 46A Work plan storage unit, 47 Interface, 48 Processor, 48A Charge remaining calculating unit, 48B Position data transmission unit, 48C Charging control unit, 48D Power supply control unit, 48E Travel control unit, 49 Main memory, 50 Storage, 51 Interface, 52 Communication device, 60 Traveling robot, 61 Power supply arm, 62 Cable, 63 Charging pad, 64 Cable

1. A system for managing a work machine, the system comprising
a processor, wherein
the processor
acquires an amount of charge remaining of a battery of each of a plurality of work machines at a work site,
determines whether a first work machine including a battery that needs to be charged is present,
determines whether a second work machine including a battery capable of charging the battery of the first work machine is present, and
outputs a charging command to charge the battery of the first work machine to the second work machine when the first work machine and the second work machine are determined to be present.

2. The system for managing a work machine according to claim 1, wherein the processor determines a first work machine having an amount of charge remaining of the battery equal to or less than a threshold to be the first work machine including the battery that needs to be charged.

3. The system for managing a work machine according to claim 1, wherein the processor determines, based on a scheduled work and an amount of charge remaining of the battery of each of the plurality of work machines, whether the first work machine including the battery that needs to be charged is present.

4. The system for managing a work machine according to claim 3, wherein the processor determines the work machine determined to use up an amount of charge remaining of the battery by end of the scheduled work to be the first work machine including the battery that needs to be charged.

5. The system for managing a work machine according to claim 4, wherein the processor determines, based on time or load required for the scheduled work, whether the first work machine including the battery that needs to be charged is present.

6. The system for managing a work machine according to claim 1, wherein the processor determines a work machine including a battery with an amount of charge remaining exceeding the amount of charge remaining of the battery of the first work machine to be the second work machine including the battery capable of charging the battery of the first work machine.

7. The system for managing a work machine according to claim 1, wherein the processor determines a second work machine having an amount of charge remaining of the battery equal to or more than a threshold to be the second work machine including the battery capable of charging the battery of the first work machine.

8. The system for managing a work machine according to claim 1, wherein the processor determines, based on a scheduled work and an amount of charge remaining of the battery of each of the plurality of work machines, whether the second work machine including the battery capable of charging the battery of the first work machine is present.

9. The system for managing a work machine according to claim 8, wherein the processor determines a work machine determined to still have an amount of charge remaining of the battery at end of the scheduled work to be the second work machine including the battery capable of charging the battery of the first work machine.

10. The system for managing a work machine according to claim 9, wherein the processor determines, based on time or load required for the scheduled work, whether the second work machine including the battery capable of charging the battery of the first work machine is present.

11. The system for managing a work machine according to claim 1, wherein the processor causes, when a plurality of the second work machines are present, the second work machine having the largest amount of charge remaining of the battery to charge the battery of the first work machine.

12. The system for managing a work machine according to claim 1, wherein
the processor
acquires a position of the first work machine and a position of the second work machine and
when a plurality of the second work machines are present, determines, based on the position of the first work machine and the positions of the second work machines, the second work machine to charge the battery of the first work machine.

13. The system for managing a work machine according to claim 1, comprising
a storage storing a work plan for each of the plurality of work machines, wherein
the processor
calculates, based on the work plan, a predicted value of power usage of the second work machine and
when a plurality of the second work machines are present, determines, based on the predicted value of the power usage, the second work machine to charge the battery of the first work machine.

14. The system for managing a work machine according to claim 13, wherein the processor causes the second work machine having the smallest predicted value of the power usage to charge the battery of the first work machine.

15. The system for managing a work machine according to claim 13, wherein
the processor
calculates, based on the work plan, a predicted value of the amount of charge remaining of the battery when work of the second work machine ends and
when a plurality of the second work machines are present, determines, based on the predicted value of the amount of charge remaining of the battery, the second work machine to charge the battery of the first work machine.

16. The system for managing a work machine according to claim 15, wherein the processor causes the second work machine including the battery with the largest predicted value of the amount of charge remaining to charge the battery of the first work machine.

17. The system for managing a work machine according to claim 1, wherein the processor transmits the charging command to an in-vehicle controller of the second work machine.

18. The system for managing a work machine according to claim 1, wherein the second work machine charges, based on the charging command received, the battery of the first work machine by wire.

19. A method for managing a work machine, the method comprising:
acquiring an amount of charge remaining of a battery of each of a plurality of work machines at a work site;
determining whether a first work machine including the battery that needs to be charged is present;
determining whether a second work machine including a battery capable of charging the battery of the first work machine is present; and
outputting a charging command to charge the battery of the first work machine to the second work machine when the first work machine and the second work machine are determined to be present.

20. A work machine comprising
a processor, wherein
the processor
acquires an amount of charge remaining of a batter of another work machine at a work site,
determines whether another work machine including a battery that needs to be charged is present, and
outputs, upon determining that the other work machine including the battery that needs to be charged is present, a charging command to charge the batter of the other work machine.
